(19) United States
(12) Patent Application Publication
(10) Pub. No.: US 2002/0118207 A1
(43) Pub. Date: Aug. 29, 2002

(54) Method and apparatus for determining graph planarity

(75) Inventor: Frank M. Jagla, Ottawa (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/742,231

(22) Filed: Dec. 22, 2000

(51) Int. Cl. G09G 5/00

(52) U.S. Cl. 345/581

(57) ABSTRACT

A method and apparatus for determining graph planarity makes use of an iterative algorithm to identify the chordless cycles in a graph and count, using a cyclic number for each link, the number of chordless cycles to which each link of the graph belongs. Chordless cycles are those cycles which can be formed without any other links of the graph forming a chord (i.e. crossing through the cycle). In order for a graph to be planar, any link cannot belong to more than two chordless cycles.

### FIELD OF THE INVENTION

The present invention relates to a method and apparatus for determining graph planarity.

### BACKGROUND OF THE INVENTION

A graph is a (usually) finite set of points called vertices (or nodes) connected by edges called links (or arcs). A graph is a planar graph if it is capable of being drawn on a plane (i.e. embedded in a plane) with no two links crossing each other except at their end vertices. A planar graph can be drawn or represented in many ways. A representation in which there are no two links crossing each other except at their end vertices is referred to as a planar representation. Determining whether or not a graph is planar is important in many applications.

For example, in integrated circuit design and the layout of printed circuit boards, it is very important to ensure that a particular circuit can be embedded in a plane without link crossings. This is a graph planarity problem.

Planarity also has implications in other areas, such as determining isomorphism of chemical structures, the analysis of networks, algorithm animation and visual computing languages, and Computer Aided Software Engineering (CASE) tools.

Existing methods for determining graph planarity rely on complex mathematical algorithms, often involving the calculation and creation of many sub-graphs and inversions of sub-graphs. These methods often require the use of complicated algorithms that are difficult to understand and implement or require a large amount of computing resources.

### SUMMARY OF THE INVENTION

The present invention is intended to provide a method and apparatus for determining graph planarity that overcomes at least some of the problems identified above.

The method and apparatus make use of an iterative algorithm to identify the chordless cycles in a graph and count, using a cyclic number for each link, the number of chordless cycles to which each link of the graph belongs. Chordless cycles are those cycles that do not have a path (a chord) between two vertices of the cycle that is not an edge of the cycle. Once all links of the graph have been examined, if any link has a cyclic number greater than two (i.e. belongs to more than two cycles), the graph is not planar since any third cycle would have to be outside of the two dimensional plane of the first two cycles.

In accordance with an aspect of the present invention there is provided a method for use in determining planarity of a graph that includes determining the number of chordless cycles to which each link of the graph belongs and evaluating whether the number of chordless cycles for the each link is less than or equal to two.

In a particular case, a method for use in determining planarity of a graph includes selecting a base vertex of the graph, constructing a minimum distance directed spanning tree from the base vertex, determining a cut tree of the spanning tree, the cut tree comprising at least one cut tree link, and determining if there are any cycles composed of cut tree links. In this case, the determining if there are any cycles may include determining if there are any persistent cycles composed of cut tree links and, if yes, determining that the graph is non-planar. Further, the determining if there are any persistent cycles composed of cut tree links may include identifying cycles composed of cut tree links, and repetitively, until there are no remaining cycles composed of cut tree links, selecting the largest cycle composed of cut tree links and forming a sub-graph, composing a directed spanning tree on the sub-graph, and determining if cycles composed of cut tree links of the sub-graph exist in the sub-graph and, if so, determining that there is a persistent cycle composed of cut tree links.

The existence of a persistent cut tree cycle occurs in certain situations and indicates that the graph is non-planar. As an example, the complete graph with 5 vertices, K₅, includes a persistent cut tree cycle and is non-planar.

In another particular case, a method for use in determining planarity of a graph includes selecting a base vertex of the graph, constructing a minimum distance directed spanning tree from the base vertex, determining a cut tree of the spanning tree, the cut tree comprising at least one cut tree link, identifying cycles related to the at least one cut tree link and the base vertex, identifying chordless cycles from amongst the identified cycles, incrementing a cyclic number for each link appearing in each of the chordless cycles, and evaluating whether the number of chordless cycles for each link exceeds two, and if so, determining that the graph is non-planar. Alternatively, the evaluating is conducted when incrementing the cyclic number for each link in the chordless cycles.

In this case, the method may also include removing vertices having a vertex degree minus a number of attached links in chordless cycles equal to zero, and where any vertices remain, repeating from the selecting by selecting a new vertex as the base vertex from amongst vertices which remain. This results in an iterative method that examines all links within the graph.

In this case, the constructing a minimum-distance directed spanning tree may include constructing a directed spanning tree in which a number of hops from the base vertex is minimized. Also, the identifying cycles related to the cut tree links and the base vertex may include, repetitively, until there are no remaining cut tree links, selecting a cut tree link with a lowest hop value, tracing from the ends of the cut tree link back to a point of intersection, and, where the intersection occurs at the base vertex, identifying a cycle formed by the cut tree link and the tracing as a cycle related to the selected cut tree link and the base vertex. Further, the identifying chordless cycles may include, repetitively, until there are no remaining cut tree links, selecting a cut tree link with a lowest hop value, determining whether or not any other cut tree links have a related cycle that includes a chord of the selected cut tree link's related cycle, and, if there is no chord, adding the related cycle of the selected cut tree link to a list of chordless cycles. In particular, the other cut tree links may be cut tree links having the same hop value as the selected cut tree link.

In yet another particular case, a method for determining planarity of a graph includes, repetitively, until there are no remaining vertices or links of the graph, selecting a vertex as a base vertex, constructing a minimum-distance directed spanning tree from the base vertex, defining a cut tree of the directed spanning tree, identifying cut tree links related to the base vertex, determining if any of the identified cut tree links form a cut tree cycle, and if so, determining if there is a persistent cut tree cycle, and if so, determining that the graph is non-planar, identifying chordless cycles for the identified cut tree links, incrementing a cyclic number for each link in the chordless cycles and determining that the graph is non-planar if the cyclic number of any link exceeds two, removing vertices having (vertex degree) minus (number of attached links in chordless cycles) equal to 0, and selecting a new base vertex from any vertices remaining in the graph.

In accordance with another aspect of the present invention there is provided a computer readable medium containing computer executable code for determining planarity of a graph which adapts a computer to determine the number of chordless cycles to which each link of the graph belongs, and evaluate whether the number of chordless cycles for the each link is less than or equal to two.

In a particular case, there is provided a computer readable medium containing computer executable code for determining planarity of a graph which adapts a computer to select a base vertex of the graph, construct a minimum distance directed spanning tree from the base vertex, obtain a cut tree of the spanning tree, the cut tree comprising at least one cut tree link, and determine if there are any cycles composed of cut tree links.

In this case, the determining may include determining if there are any persistent cycles composed of cut tree links and, if yes, determining that the graph is non-planar. Further, the determining if there are any persistent cycles composed of cut tree links may include identifying cycles composed of cut tree links, and repetitively, until there are no remaining cycles composed of cut tree links, selecting the largest cycle composed of cut tree links and forming a sub-graph, composing a directed spanning tree on the sub-graph, and determining if cycles composed of cut tree links of the sub-graph exist in the sub-graph and, if so, determining that there is a persistent cycle composed of cut tree links. In a more particular case, the determining if there are any persistent cycles composed of cut tree links may further include, where there is not a persistent cycle, selecting links forming an open Hamiltonian walk from the sub-graph. In this more particular case, the computer may be further adapted to include the selected links as cut tree links, identify cut tree links related to the base vertex, identify chordless cycles for the identified cut tree links, and increment a cyclic number for each link in the chordless cycles and determining that the graph is non-planar if the cyclic number of any link exceeds two. Still further, the computer may also be further adapted to remove vertices having (vertex degree) minus (number of attached links in chordless cycles) equal to 0, and select a new base vertex from any vertices remaining in the graph.

In accordance with another aspect of the present invention there is provided an apparatus for determining planarity of a graph including an input device for inputing a graph, a computer, and an output device for outputting a planarity result, wherein the computer is adapted to determine the number of chordless cycles to which each link of the graph belongs, and evaluate whether the number of chordless cycles for the each link is less than or equal to two.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a schematic diagram of an apparatus according to an embodiment of the invention;

FIG. 2 is a flow chart showing a method for determining graph planarity according to an embodiment of the invention;

FIG. 3a is a table showing graph links for an example graph;

FIG. 3b is a representation of a graph using the links of FIG. 3a;

FIG. 3c is a representation of the graph of FIG. 3b, showing a directed spanning tree and a cut tree;

FIG. 3d is a representation of a sub-graph obtained during processing of the graph of FIG. 3d;

FIG. 3e is a is a representation of the sub-graph of FIG. 3d, showing a directed spanning tree and a cut tree;

FIG. 4 is a flow chart showing a method for identifying cycles related to a base vertex;

FIG. 5 is a flow chart showing a method for a cycle test;

FIG. 6 shows a representations of a sub-graph of the graph of FIG. 3 illustrating the definition of a chordless cycle;

FIG. 7 is a flow chart showing a method for identifying chordless cycles of a base vertex; and

FIGS. 8a to 8 g show a method according to an embodiment of the invention performed on an second example graph.

### DETAILED DESCRIPTION

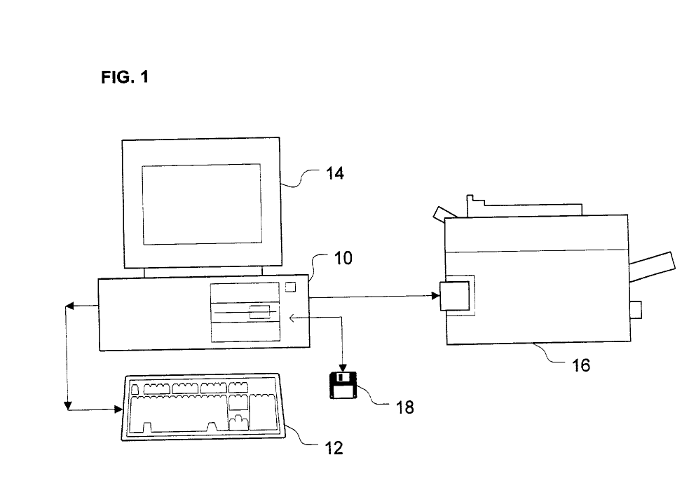

Referring to FIG. 1, an apparatus for determining graph planarity includes a computer 10, an input device, such as a keyboard 12, a mouse (not shown), a network connection (not shown) or other input device as would be known to one of skill in the art, and an output device, such as a monitor 14, a printer 16, computer media such as a floppy disk 18, or other output device. The computer 10 may be a general purpose computer or a computer designed for this particular function. The computer is adapted to implement the method described below by executing commands stored in a computer memory (not shown) or stored on the floppy disk 18 or on other computer media such as a hard disk (not shown) or as is known in the art.

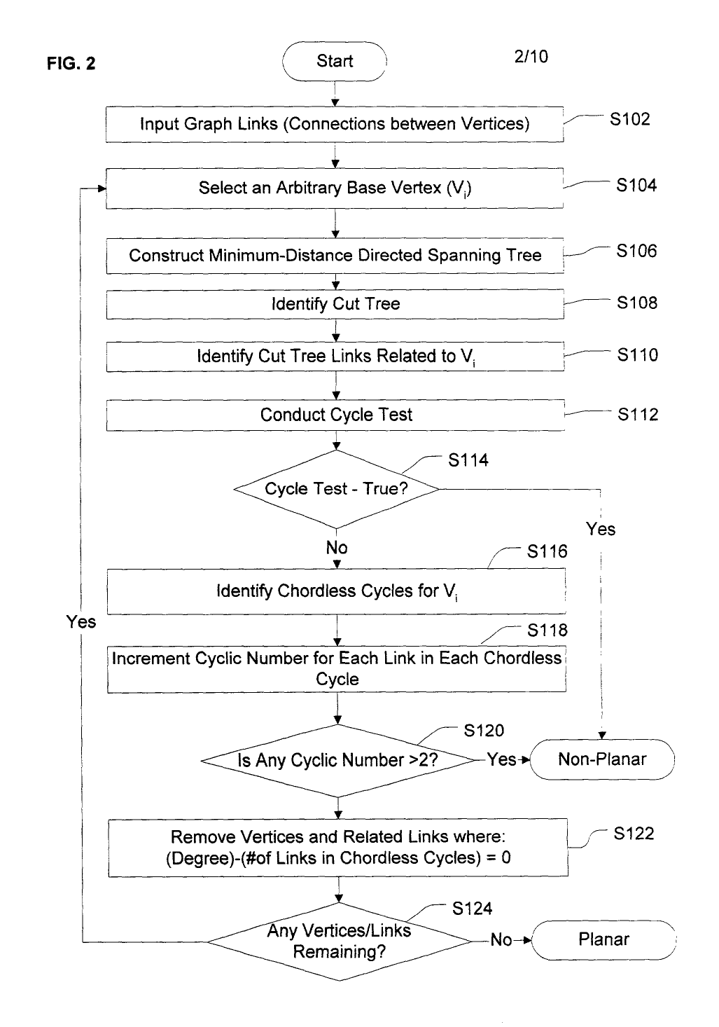

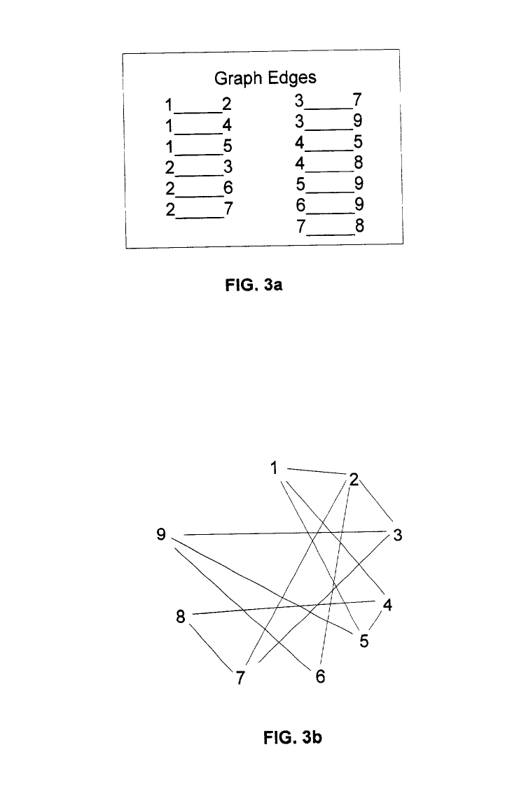

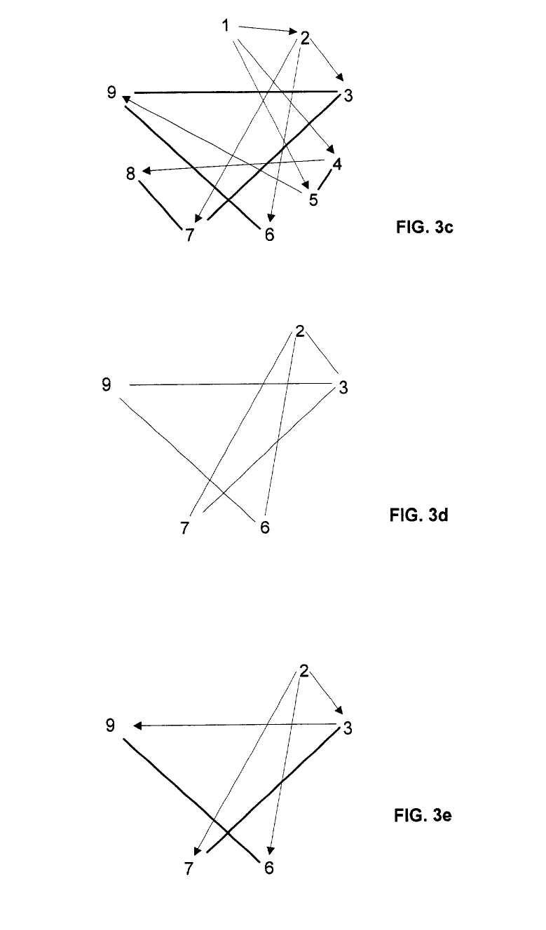

FIG. 2 is a flow chart showing a planarity test method for determining graph planarity according to an embodiment of the invention. For ease of explanation, the planarity test method will be described in conjunction with an example shown in FIGS. 3a-3e.

As described above, a graph is a finite set of points called vertices (or nodes) connected by edges called links (or arcs). Each vertex of the graph is given an identifier, for example, the vertices may be sequentially numbered from “1”. A graph link is designated by the identifiers of the vertices to which it is connected. The planarity test method described herein is not applicable to pseudographs (graphs that contain a loop) and multigraphs (graphs that contain parallel edges between two vertices).

The method begins with the input of graph links, for example, through the keyboard 12(S102). An example of a list of graph links is shown in FIG. 3a.

FIG. 3b shows one representation of a graph created from the graph links indicated in FIG. 3a. This representation of the graph is formed by arranging the numbered vertices in a circular/elliptical form and adding the links connecting vertices. It is apparent that the representation of the graph shown in FIG. 3b is not a planar representation because a number of the links overlap at points other than at the vertices. The method described herein is used to determine if the graph shown in FIG. 3b is a planar graph, that is, is capable of a planar representation.

Returning to FIG. 2, an arbitrary vertex V₁ is chosen as the base vertex (S104). In the example, we choose vertex V₁.

In the next step (S106), a minimum distance directed spanning tree is constructed from Vᵢ. A spanning tree is a subgraph that contains, or covers, all the vertices of the original graph but not necessarily all of the links. A directed graph or directed spanning tree is one in which each of the links has initial and terminating vertices to give the link a direction. More particularly, a directed spanning tree for a vertex V₁ is a subgraph that includes a single path originating from the vertex V₁ to each of the other vertices of the original graph along existing links of the graph. In the method of this invention, the directed spanning tree is also constructed such that the distance from the base vertex V₁ to each other vertex is minimized. The distance from the base vertex Vᵢ to a vertex in question is calculated based on the number of hops, i.e. vertices, from the base vertex V₁ through the directed spanning tree to the vertex in question. In counting hops, vertices of degree two are not counted, where the degree of a vertex is the number of links that attach to that vertex.

For the graph of FIG. 3b, the minimum distance directed spanning tree is shown by the links with arrows in FIG. 3c. By way of example, it will be noted in FIG. 3c, that the minimum distance (number of hops) from the base vertex V₁ to vertex V₇ is minimized by using the path 1-2, 2-7 (two hops) in the directed spanning tree rather than the path 1-2, 2-3, 3-7 (three hops). Note also that since vertices of degree two are not counted in determining the number of hops, the vertices V₆ and V₈. are both considered only 1 hop (1-2 and 1-4, respectively) from the base vertex V_{1.}

Once a minimum distance directed spanning tree is created, there will be a number of links that are not members of the minimum distance directed spanning tree. These links define a “cut tree” in that they are cut out as not being members of the minimum distance directed spanning tree. These cut tree links are identified at step S108. In FIG. 3c, the cut tree links are shown as bold lines without arrows. The cut tree links are 3-7, 3-9, 4-5, 6-9, and 7-8.

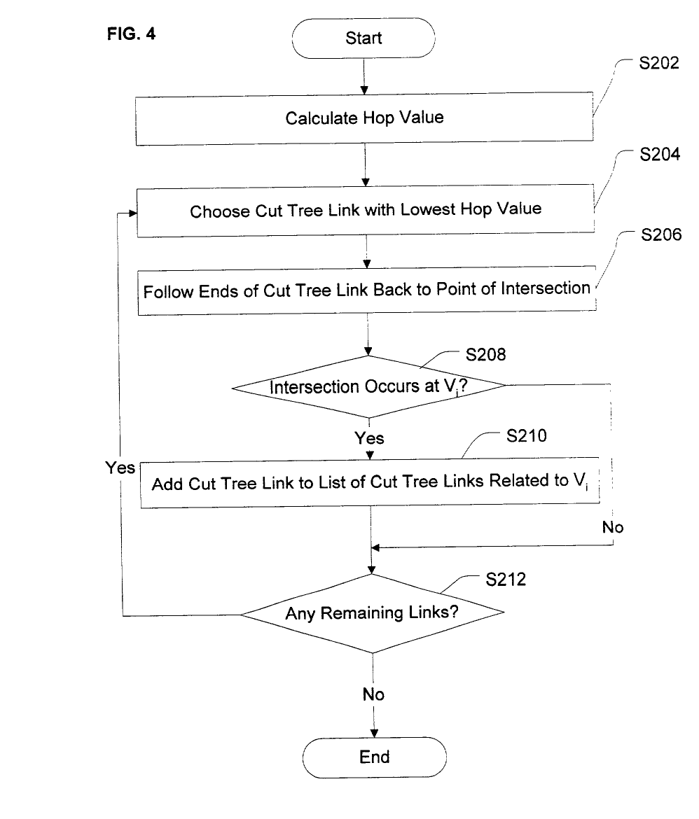

Next, it is determined which of the cut tree links are related to the base vertex V₁ (S110). This determination is made in order to reduce the number of cut tree links to be examined in subsequent procedures. A related links procedure (conducted at S110) is shown in FIG. 4.

In the related links procedure, a hop value hₑ is calculated for each cut tree link (S202). The hop value hₑ for a cut tree link “e” represents the sum of the number of hops in the directed spanning tree from the base vertex V₁ to the two vertices at which the cut tree link terminates. Again, vertices of degree 2 are not counted as a hop. In calculating hop value hₑ, it is convenient to consider a cycle formed to include the relevant cut tree link and the links of the directed spanning tree leading to the base vertex V₁. A cycle is any path in a graph beginning at one vertex and returning to the same vertex following links of the graph. For example, in FIG. 3c, the cut tree link 6-9 is a member of the cycle 6-2-1-5-9 (-6) and has a hop value h₆₋₉ of 3 because there are two hops, 1-5, 5-9 to the vertex V₉ and one hop 1-2 to the vertex V₆ (the link 2-6 is not counted because the vertex V₆ is of degree 2).

Next, a cut tree link is selected from among those with the lowest hop value hₑ, (S204) and the ends of the selected cut tree link are traced back along the directed spanning tree to the first vertex of intersection (S206). In this regard, the trace back occurs in parallel from each end of the cut tree link so that the first vertex of intersection is accurately determined. If the intersection occurs at the base vertex Vᵢ (S208), the cut tree link is added to the list of cut tree links related to the base vertex V₁ (S210). It is then determined if there are any remaining cut tree links to be tested (S212). If yes, the procedure returns to S202 and another cut tree link is chosen, otherwise the procedure ends.

In the example, the cut tree link 4-5 has the lowest hop value h₄₋₅ (=2) and is selected. The cut tree link 4-5 has a path from vertex V₄ back to the base vertex V₁ and a path back from vertex V₅ to V₁ with no other intersections. Therefore, the cut tree link 4-5 is related to the base vertex V₁. In contrast, for the cut tree link 3-7, the links back from vertex V₃ and vertex V₇ first intersect at the vertex V₂. That is, vertex V₃ is traced back to vertex V₂ and vertex V₇ is traced back to vertex V₂ indicating an intersection at vertex V₂. Thus, the cut tree link 3-7 is not related to the base vertex V₁.

Table 1 indicates, for the example, each cut tree link, the cycle it is a member of, the hop value hₑ for the cut tree link, and whether or not the cut tree link is related to the base vertex V₁.

TABLE 1

| Cut | | | |
|---|---|---|---|
| Tree | | | |
| Link | Cycle | Hop Value hₑ | Related to Vertex V₁ |
| 4-5 | 4-1-5(-4) | 2 | Yes |
| 6-9 | 6-2-1-5-9(-6) | 3 (vertex 6 is of degree 2) | Yes |
| 7-8 | 7-2-1-4-8(-7) | 3 (vertex 8 is of degree 2) | Yes |
| 3-7 | 3-2-1-2-7(-3) | 4 | No, intersects at V₂ |
| 3-9 | 3-2-1-5-9(-3) | 4 | Yes |

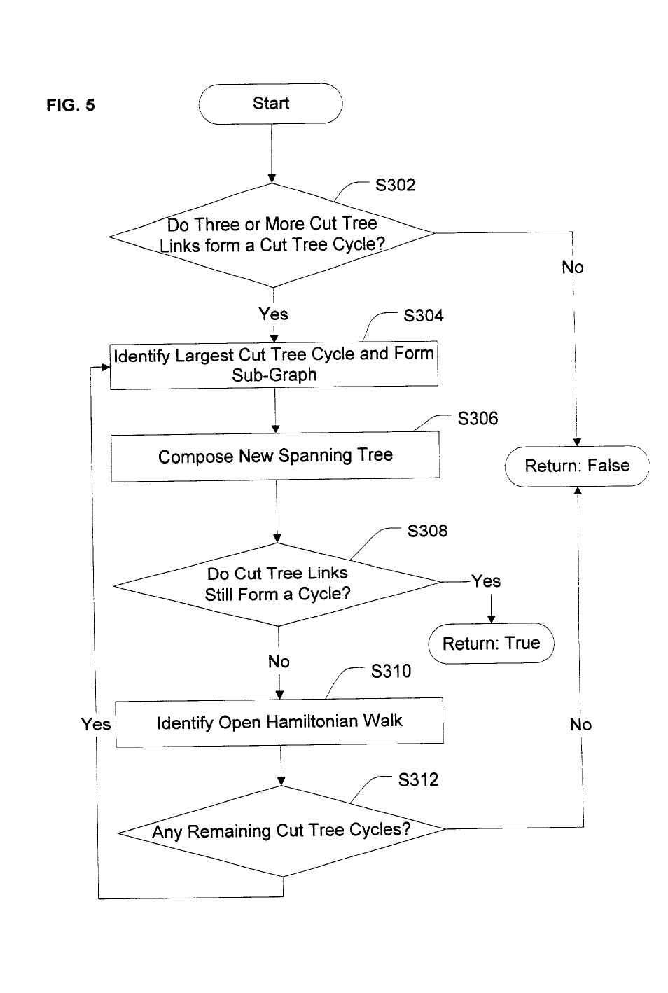

In the next step of the planarity test method (S112), a cut tree cycle test, shown in FIG. 5, is conducted to check whether any of the cut tree links related to the base vertex Vᵢ themselves form a cycle, referred to as a “cut tree cycle”, and, if yes, whether or not a cut tree cycle remains (as a “persistent cut tree cycle”) under an alternate spanning tree. The existence of a persistent cut tree cycle occurs in certain situations and indicates that the graph is non-planar. As an example, the complete graph with 5 vertices, K₅, includes a persistent cut tree cycle and is non-planar.

Referring to FIG. 5, the cut tree cycle test procedure begins by determining whether three or more cut tree links compose a cut tree cycle (S302). Cut tree links that are not related to the base vertex V₁ do not need to be examined at this stage. For example, the determination of whether or not the cut tree links form a cut tree cycle may be done by tracing connected cut tree links to determine if there is a point of intersection forming a cycle. If there are no cut tree cycles, the cut tree cycle test returns a value of false. In the example of FIG. 3, there are no cut tree cycles and a false value would be returned at this point. If there is a cut tree cycle, the vertices and links forming the largest cut tree cycle and any included vertices and links (i.e. vertices and links that are in the space bounded by the cycle) are identified and used to form a cut tree sub-graph (S304). Next, a minimum distance directed spanning tree is determined for an arbitrary vertex of the cut tree sub-graph (S306) and it is determined if any of the new cut tree links in the cut tree sub-graph form a cut tree cycle in the new spanning tree (S308). If there is still a cut tree cycle, the cyclic test returns true indicating a persistent cut tree cycle. If there is no longer a cut tree cycle, an open Hamiltonian walk of the cut tree sub-graph is used to select cut tree links for inclusion in the list of cut tree links relating to the base vertex V₁, while other cut tree links are left for later processing (S310). There will be at least one open Hamiltonian walk. An open Hamiltonian walk is a path in a graph that reaches each vertex of the graph only once.

Next, it is determined if there are any remaining cut tree cycles (S312). If there are no remaining cut tree cycles, the cut tree cycle test procedure returns false. If there are remaining cut tree cycles, the cut tree cycle test procedure returns to S304 to select the next largest cut tree cycle from the remaining cycles. The cut tree cycle test procedure continues until there are no remaining cut tree cycles. In this process, if, at any stage, there are any persistent cut tree cycles, the cut tree cycle test procedure returns true, otherwise, the cut tree cycle test procedure returns false.

Returning to FIG. 2, at S114, if the cut tree cycle test returns true then the graph is non-planar and the procedure indicates non-planarity and terminates. If the cut tree cycle test returns false, the procedure continues to S116.

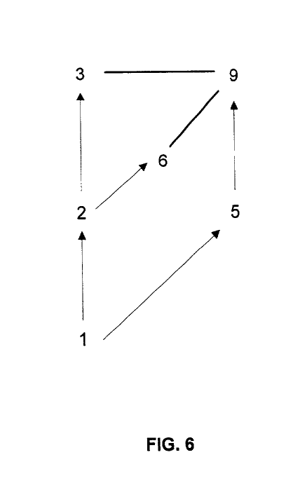

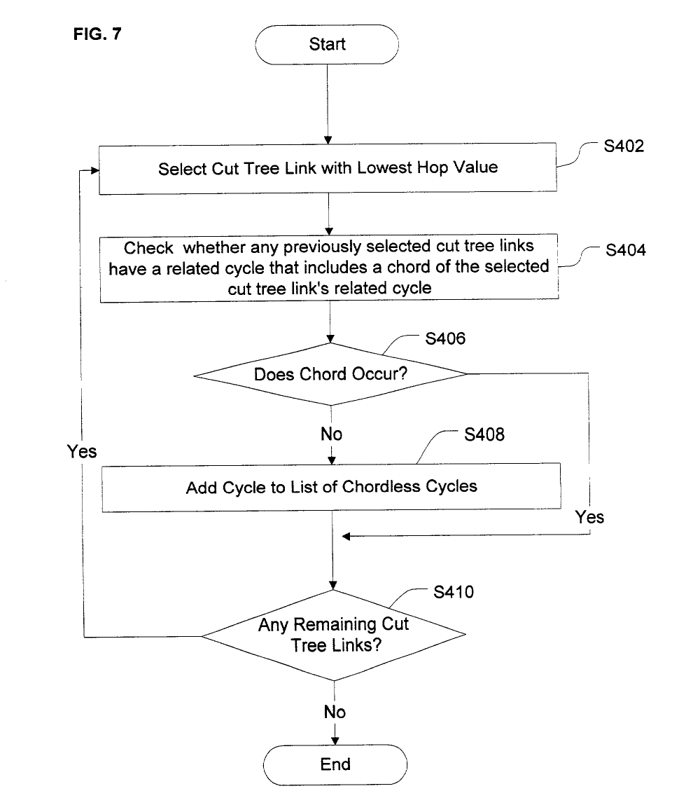

The next step is to identify chordless cycles for the base vertex V₁ by using the cut tree links related to the base vertex Vᵢ (S116). A chordless cycle procedure is shown in FIG. 7, however, it is first useful to define certain concepts. As indicated above, a cycle is any path in a graph beginning at one vertex and returning to the same vertex following links of the graph. A chord of a cycle is a path between two vertices of the cycle that is not an edge of the cycle. A chordless cycle is a cycle that does not have any chords. The concept of a chordless cycle is explained with reference to FIG. 6. FIG. 6 shows a planar representation of a sub-graph of the graph of FIG. 3. There are three cycles 1-2-6-9-5(-1), 1-2-3-9-5(-l) and 2-3-9-6 (-2). (Note that the number in parentheses is shown only to indicate the completion of the cycle.) The cycles 1-2-6-9-5(-l) and 2-3-9-6 (-2) are chordless cycles whereas the cycle 1-2-3-9-5(-1) is not because of the path 2-6-9 that passes between vertex V₂ and vertex V₉ but is not an edge of the cycle 1-2-3-9-5(-1). When examining chordless cycles for a particular vertex, for example vertex V₁, only the cycles containing that vertex are examined, thus in FIG. 6, the cycles for vertex V₁ are 1-2-6-9-5(-1) and 1-2-3-9-5(-1) and the only chordless cycle is 1-2-6-9-5(-1).

The chordless cycle procedure is shown in FIG. 7. The chordless cycle procedure also uses the hop value hₑ from the base vertex V₁ for each cut tree link. As described above, the hop value hₑ for a cut tree link “e” represents the sum of the number of hops in the directed spanning tree from the base vertex Vᵢ to the two vertices at which the cut tree link terminates. Again, vertices of degree 2 are not counted as a hop. Also as indicated above, the cut tree links related to the base vertex Vᵢ and the links connecting the ends of the cut tree link to the base vertex V₁ form a cycle related to the cut tree link. Using the example shown in FIG. 3c, Table 2 herein shows the cut tree links related to the base vertex V₁, their related cycles, and hop values hₑ. Note that, in the cycle column (column 2), the number in parentheses is shown only to indicate the completion of the cycle, not as an additional link.

TABLE 2

| Cut | | | |
|---|---|---|---|
| Tree | | | |
| Link | Cycle | Hop Value hₑ | Chordless Cycle |
| 4-5 | 4-1-5(-4) | 2 | Yes |
| 6-9 | 6-2-1-5-9(-6) | 3 (vertex 6 is of degree 2) | Yes |
| 7-8 | 7-2-1-4-8(-7) | 3 (vertex 8 is of degree 2) | Yes |
| 3-9 | 3-2-1-5-9(-3) | 4 | No, chord is 9-6-2 |

The chordless cycle procedure shown in FIG. 7 determines whether or not a related cycle for a cut tree link is a chordless cycle (column 4 of Table 2). First, a cut tree link is selected from among those related to the base vertex V₁ and having the lowest hop value hₑ (S402). The ends of the selected cut tree link are then traced back toward the base vertex Vᵢ to determine whether or not any cut tree links having the same or lower hop value hₑ have a related cycle that includes a chord of the selected cut tree link's related cycle (S404). In the example of FIG. 3c, the cut tree link 4-5 has the lowest hop value hₑ and has a related cycle that is a chordless cycle because there are no cut tree links having the same or lower hop value hₑ that may form chords on the path back to the base vertex V₁. In examining the cut tree link 6-9, a trace back indicates that the vertex V₅ (from the cut tree link 4-5) is on the path from vertex V₉ to the base vertex V₁, however, a trace back from vertex V₆ to the base vertex V₁ does not have any links connecting to vertex V₄ (from the cut tree link 4-5) and thus the cut tree link 6-9 also forms a chordless cycle. However, in the case of the cut tree link 3-9, which is shown in a different representation in FIG. 6 for a clearer understanding, the vertex V₉ is already present in the cut tree link 6-9 (having the same hop value hₑ) and a trace back from the vertex V₃ contacts the vertex V₂ which is also included in the chordless cycle relating to the cut tree link 6-9. This indicates that the cycle relating to the cut tree link 3-9 is not a chordless cycle. In this case, the path 9-6, 6-2 is identified as a chord of the cycle relating to the cut tree link 3-9 and the vertex V₆ is identified as being on a chord to indicate that it will not be removed at a later stage as described below.

If there is no chord (S406), the cycle is added to the list of chordless cycles (S408). For the example, Table 2 above indicates the cut tree links, their related cycles, and whether or not they are included in the list of chordless cycles.

It is then checked if there are any more cut tree links to be examined (S410). If so, the chordless cycle procedure returns to S402 to examine the next cut tree link, if not, the procedure ends and returns to S116 of FIG. 2.

Next, at S118 of FIG. 2, each chordless cycle determined in S116 is examined and a cyclic number for each link in the chordless cycle, whether a cut tree link or not, is incremented by one. The cyclic number for a link is therefore a counter that represents the number of chordless cycles of which the link is a member. In the example, the cycles 4-5-(-1); 6-2-1-5-9(-6) and 7-2-1-4-8(-7) are the chordless cycles from S116. Table 3, second column, shows the resulting cyclic numbers for each link in the example (which, for reasons which will become apparent, is labelled the first iteration: It.#1).

TABLE 3
Cyclic Numbers
(incrementing)

| Edges | It. #1 | It. #2 | Total |
|---|---|---|---|
| 1-2 | 2 | | 2 |
| 1-4 | 2 | | 2 |
| 1-5 | 2 | | 2 |
| 2-3 | | 2 | 2 |
| 2-6 | 1 | 1 | 2 |
| 2-7 | 1 | 1 | 2 |
| 3-7 | | 1 | 1 |
| 3-9 | | 1 | 1 |
| 4-5 | 1 | | 1 |
| 4-8 | 1 | | 1 |
| 5-9 | 1 | | 1 |
| 6-9 | 1 | 1 | 2 |
| 7-8 | 1 | | 1 |

There is then a test to determine if any cyclic number is greater than two (S120). If any link belongs to more than two chordless cycles, the graph is non-planar and the method ends by indicating this result, however, if not, the method continues.

In the next step (S122), with two exceptions, the vertices at which the equation:

(vertex degree)−(number of links to vertex in chordless cycles)=0,

is true are removed from the original graph along with the links attached to such vertices. As described above, the degree of a vertex is the number of links that attach to that vertex. The exceptions are that vertices previously identified as being on a chord and vertices that initially belonged to a cut tree cycle (i.e. previously part of a Hamiltonian walk) must remain in the graph.

In the example of FIG. 3b, vertex V₂ has degree 4 and, from the list of chordless cycles identified in Table 2, it is apparent that only three links 1-2, 2-6, 2-7 of the four links connected with vertex V₂ are included in chordless cycles, therefore the vertex V₂ remains in the graph. For vertex V₄, of degree 3, the three links 4-5, 4-1 and 4-8 are all included in chordless cycles; thus vertex V₄ is removed, as are all links to Vertex V₄. Although vertex V₆ has degree 2 and the links 2-6 and 6-9 are included in chordless cycles, it was determined above that vertex V₆ is on a chord and thus must remain in the graph. The resulting reduced graph is shown in FIG. 3d.

Next, it is determined if there are any vertices or links remaining in the reduced graph (S124). If no, the method ends indicating that the graph is planar. If there are vertices and links remaining in the reduced graph, the procedure returns to step S104 to select a new arbitrary base vertex V₁ from the remaining vertices in the reduced graph.

In the example, we choose a new base vertex V₁=V₂ (S104), construct a new minimum distance directed spanning tree as shown in FIG. 3e (S106), and determine that the cut tree links are 3-7 and 6-9 (S108), both of which are related to the base vertex V₂ (S110). Further, since there are only two cut tree links there can be no cut tree cycles (S112, S114). The cycle related to the cut tree link 6-9 is determined to be a chordless cycle (S116) because, even though a trace back from vertex V₉ encounters the vertex V₃ (from the previous cut tree link 3-7), a trace back from the vertex V₆ returns directly to the base vertex V₂ and there is no chord. The cut tree links, related cycles, hop values, and determination of whether or not a chordless cycle are shown in Table 4 below herein.

TABLE 4

| Cut Tree | | | Chordless |
|---|---|---|---|
| Link | Cycle | Hop Value hₑ | Cycle |
| 3-7 | 3-2-7(-3) | 1 (vertex 7 is of degree 2) | Yes |
| 6-9 | 6-2-3-9(-6) | 1 (vertices 6 and 9 are of degree 2) | Yes |

Next, cyclic numbers for each link are incremented (second iteration) as shown in column 3 of Table 3 (S118) and the cyclic numbers from the second iteration are added to those of the fist iteration (see column 4 of Table 3). In the example, since no cyclic numbers are greater than 2 (see column 4 of Table 3) (S120), the procedure continues to S122 and vertices and links are removed according to the rule described above. At this point in the example, there are no vertices or links remaining (S124) and the method ends indicating a planar graph.

The result of the planarity test method can be output to an output device such as the monitor 14, the printer 16 (via memory, if necessary). Additionally, the output could be to an input of a printed circuit board fabrication system or other system utilizing the result of the planarity test.

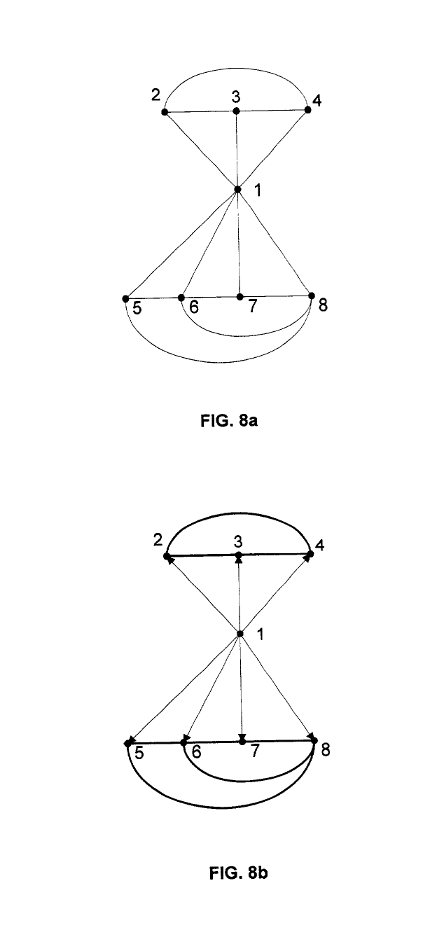

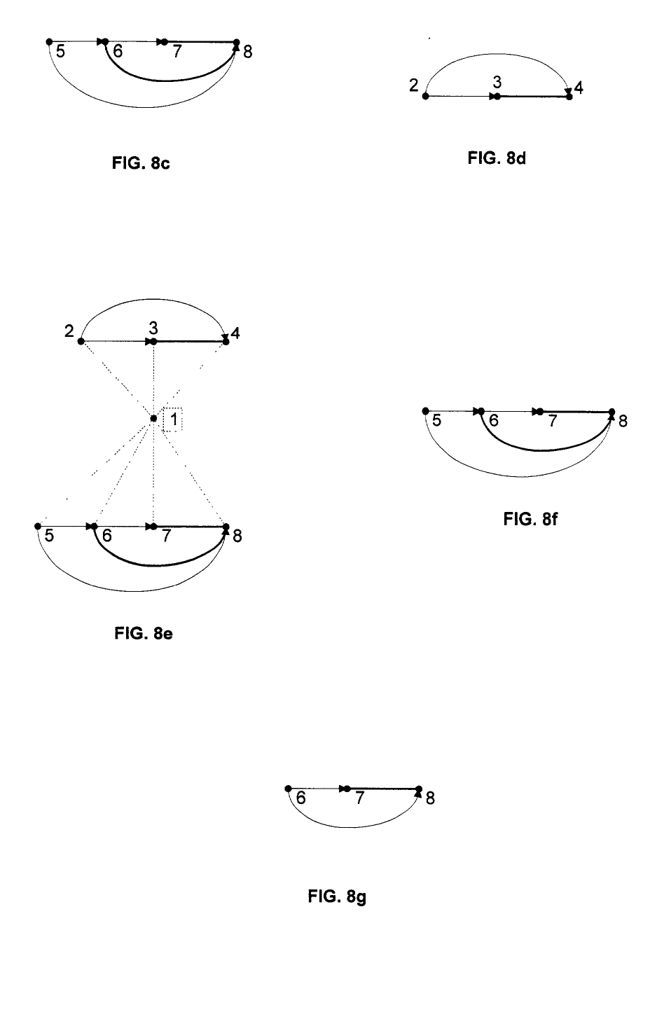

FIG. 8 shows a second example graph that may better illustrate the principles of the cut tree cycle procedure of FIG. 5. FIG. 8a shows the example graph drawn in a planar representation. FIG. 8b shows the example graph after applying the minimum distance directed spanning tree and identifying the cut tree links (bold lines without arrows). Table 5 shows the cut tree links, their related cycles (i.e. a cut tree link and the links from each of its vertices to the base vertex V₁), hop values, and whether or not the cut tree links are related to the base vertex V₁. As indicated in Table 5, it is clear that tracing back indicates that each of the cut tree links relates to the base vertex V₁.

TABLE 5

| Cut | | Hop | Related |
|---|---|---|---|
| Tree Link | Cycle | Value hₑ | to Vertex V₁ |
| 2-3 | 2-1-3(-2) | 2 | Yes |
| 2-4 | 2-1-4(-2) | 2 | Yes |
| 3-4 | 3-1-4(-3) | 2 | Yes |
| 5-6 | 5-1-6(-5) | 2 | Yes |
| 5-8 | 5-1-8(-5) | 2 | Yes |
| 6-7 | 6-1-7(-6) | 2 | Yes |
| 6-8 | 6-1-8(-6) | 2 | Yes |
| 7-8 | 7-1-8(-7) | 2 | Yes |

In the cut tree cycle test of FIG. 5, examination of the cut tree links indicates that there are a number of cut tree cycles (i.e. cycles formed of only cut tree links): 2-3-4(-2), 5-6-7-8(-5), and 6-7-8(-6). The largest cut tree cycle is 5-6-7-8(-5) which also includes all of the vertices of the cycle 6-7-8(-6). This cut tree cycle forms the cut tree sub-graph shown in FIG. 8c. In FIG. 8c, a minimum distance directed spanning tree has been formed from the base vertex V₅ and the cut tree links for this sub-graph are shown by bold lines. Since there are only two cut tree links, 6-8 and 7-8, in the sub-graph there is no new cut tree cycle and therefore, no persistent cut tree cycle. An open Hamiltonian walk of the sub-graph is selected as 5-6-7-8 and the cut tree links 5-6, 6-7, 7-8 are selected for inclusion on the list of cut tree links relating to the original base vertex V₁ while the cut tree links 5-8 and 6-8 are left for later processing. Similarly, in FIG. 8d, a minimum distance spanning tree has been formed from the base vertex V₂. Again, there is no persistent cut tree cycle and the cut tree links 2-3 and 3-4 are selected for inclusion in the list of cut tree links related to the base vertex V₁. In the above, other open Hamiltonian walks are also acceptable. For example, a walk from 2-4-3 results in the links 2-4 and 4-3 being selected. There are then no remaining cut tree cycles and the cut tree cycle procedure returns false.

In the chordless cycle procedure of FIG. 7, the cut tree links relating to the base vertex V₁ are examined to determined if their related cycles are chordless cycles. Table 6 lists the cut tree links relating to the base vertex V₁, their related cycles, hop values hₑ and whether or not they are chordless cycles. In this example, tracing back of the cut tree cycles indicates that there are no links of any of the related cycles forming a chord or any of the other related cycles and thus, the cycles related to all of the cut tree links are chordless cycles. For example, in examining the cycle 2-1-3(-2), the vertex V₃ is also on the cycle 3-1-4(-3) however, there are no other vertices common to both cycle and there is no chord. None of the other cycles includes any vertices in common with the cycle 2-1-3(-2) and thus also do not include chords.

TABLE 6

| Cut | | Hop | Chordless |
|---|---|---|---|
| Tree Link | Cycle | Value hₑ | Cycle |
| 2-3 | 2-1-3(-2) | 2 | Yes |
| 3-4 | 3-1-4(-3) | 2 | Yes |
| 5-6 | 5-1-6(-5) | 2 | Yes |
| 6-7 | 6-1-7(-6) | 2 | Yes |
| 7-8 | 7-1-8(-7) | 2 | Yes |

Table 7, column 2 shows the incrementing of cyclic numbers for this example graph. The results for the links based on the chordless cycles of Table 6 are shown in the second column as the first iteration: It.#1.

TABLE 7
Cyclic Numbers
(incrementing)

| Edges | It.#1 | It.#2 | It.#3 | It.#4 | Total |
|---|---|---|---|---|---|
| 1-2 | 1 | | | | 1 |
| 1-3 | 2 | | | | 2 |
| 1-4 | 1 | | | | 1 |
| 1-5 | 1 | | | | 1 |
| 1-6 | 2 | | | | 2 |
| 1-7 | 2 | | | | 2 |
| 1-8 | 1 | | | | 1 |
| 2-3 | 1 | 1 | | | 2 |
| 2-4 | | 1 | | | 1 |
| 3-4 | 1 | 1 | | | 2 |
| 5-6 | 1 | | 1 | | 2 |
| 5-8 | | | 1 | | 1 |
| 6-7 | 1 | | | 1 | 2 |
| 6-8 | | | 1 | 1 | 2 |
| 7-8 | 1 | | | 1 | 2 |

After the first iteration (It.#1), the vertices and links are removed from the graph according to the procedure described above. In this case, links that originally formed a cut tree cycle and their vertices remain in the reduced graph. For example, even though vertex V₃ is of degree 3 and the three links 1-3, 2-3, and 3-4 are included in chordless cycles, the vertex V₃ remains since it was part of a cut tree cycle. The reduced graph is shown in FIG. 8e (with the removed links and vertex V₁ shown as hidden lines). It is convenient to use the minimum distance directed spanning trees determined in the cut tree cycle test procedure (described in conjunction with FIGS. 8c and 8d above) for the remaining vertices and links, as shown in FIG. 8e.

Choosing the vertex V₂ as the new base vertex (consistent with the choice in the cut tree cycle test procedure) gives a cut tree link 3-4 relating to the base vertex V₂ and a chordless cycle 3-2-4(-3). The cut tree links 6-8 and 7-8 clearly do not relate to the base vertex V₂ because they do not intersect at the base vertex V₂ as determined in the related links procedure of FIG. 4. The cyclic numbers for the links in the chordless cycle 3-2-4(-3) are incremented by the amount shown in Table 7, column 3 (the second iteration: It.#2). Again, vertices and links are then removed and the reduced graph is shown in FIG. 8f.

Vertex V₅ is chosen as the new base vertex (again consistent with the choice in the cut tree cycle test procedure). The cut tree links are 6-8 and 7-8 with related cycles 6-5-8(-6) and 7-6-5-8(-7) both having hop value hₑ=2. Since the cycle 6-5-8(-6) is included within the cycle 7-6-5-8(-7), i.e. tracing the ends of the cycle 7-6-5-8(-7) back contacts both vertex V₈ and vertex V₆ that are in the cycle 6-5-8(-6), the cycle 7-6-5-8(-7) is not chordless. The cyclic numbers for the links in the cycle 6-5-8(-6) are incremented by the amount shown in Table 7, column 4 (the third iteration: It.#3). Again, the vertices are removed and the reduced graph is shown in FIG. 8g.

Vertex V₆ is chosen as the new base vertex. The only cut tree link is 7-8 with related cycle 7-6-8(-7). The cyclic numbers for the links are incremented by the amount shown in Table 7, column 5 (the fourth iteration: It.#4). The vertices are removed and, at this point, there are no vertices or links remaining.

The total cyclic number for each link is shown in Table 7, column 6. In this example graph, since none of the cyclic numbers is greater than 2, the graph is determined to be planar, which confirms the planar representation shown in FIG. 8a.

As noted above, in these embodiments, the identification of cut tree links that relate to the base vertex is performed in order to reduce the number of links that need to be examined in the cut tree cycle test and in the chordless cycle procedure. Alternatively, this identification could also be performed as a part of either of the cut tree cycle test and the chordless cycle procedure.

As will be apparent to one of skill in the art, the method described above may be implemented in software or in hardware or in a combination thereof.

Other modifications will be apparent to those skilled in the art and, therefore, the invention is defined in the claims. cm What is claimed is:

1. A method for use in determining planarity of a graph comprising:
determining the number of chordless cycles to which each link of the graph belongs; and
evaluating whether the number of chordless cycles for said each link is less than or equal to two.

2. A method for use in determining planarity of a graph, comprising:
selecting a base vertex of the graph;
constructing a minimum distance directed spanning tree from said base vertex;
determining a cut tree of said spanning tree, said cut tree comprising at least one cut tree link; and
determining if there are any cycles composed of cut tree links.

3. The method of claim 2, wherein said determining if there are any cycles comprises determining if there are any persistent cycles composed of cut tree links and, if yes, determining that said graph is non-planar.

4. The method of claim 3, wherein said determining if there are any persistent cycles composed of cut tree links comprises:
identifying cycles composed of cut tree links;
repetitively, until there are no remaining cycles composed of cut tree links:
selecting the largest cycle composed of cut tree links and forming a sub-graph;
composing a directed spanning tree on said sub-graph; and
determining if cycles composed of cut tree links of said sub-graph exist in said sub-graph and, if so, determining that there is a persistent cycle composed of cut tree links.

5. A method for use in determining planarity of a graph, comprising:
selecting a base vertex of the graph;
constructing a minimum distance directed spanning tree from said base vertex;
determining a cut tree of said spanning tree, said cut tree comprising at least one cut tree link;
identifying cycles related to said at least one cut tree link and said base vertex;
identifying chordless cycles from amongst said identified cycles;
incrementing a cyclic number for each link appearing in each of said chordless cycles; and
evaluating whether the number of chordless cycles for each link exceeds two, and if so, determining that said graph is non-planar.

6. The method of claim 5, further comprising:
removing vertices having a vertex degree minus a number of attached links in chordless cycles equal to zero; and
where any vertices remain, repeating from said selecting by selecting a new vertex as said base vertex from amongst vertices which remain.

7. The method of claim 5, wherein said evaluating is conducted when incrementing said cyclic number for each link in said chordless cycles.

8. The method of claim 5, wherein said constructing a minimum-distance directed spanning tree comprises constructing a directed spanning tree in which a number of hops from said base vertex is minimized.

9. The method of claim 5, wherein said identifying cycles related to said cut tree links and said base vertex comprises:
repetitively, until there are no remaining cut tree links:
selecting a cut tree link with a lowest hop value;
tracing from the ends of the cut tree link back to a point of intersection; and
where said intersection occurs at said base vertex, identifying a cycle formed by said cut tree link and said tracing as a cycle related to said selected cut tree link and said base vertex.

10. The method of claim 5, said identifying chordless cycles comprising:
repetitively, until there are no remaining cut tree links:
selecting a cut tree link with a lowest hop value;
determining whether or not any other cut tree links have a related cycle that includes a chord of the selected cut tree link's related cycle; and
if there is no chord, adding said related cycle of said selected cut tree link to a list of chordless cycles.

11. The method of claim 10, wherein said other cut tree links are cut tree links having the same hop value as said selected cut tree link.

12. A method for determining planarity of a graph comprising:
repetitively, until there are no remaining vertices or links of the graph:
selecting a vertex as a base vertex;
constructing a minimum-distance directed spanning tree from said base vertex;
defining a cut tree of the directed spanning tree;
identifying cut tree links related to said base vertex;
determining if any of said identified cut tree links form a cut tree cycle, and if so, determining if there is a persistent cut tree cycle, and if so, determining that the graph is non-planar;
identifying chordless cycles for said identified cut tree links;
incrementing a cyclic number for each link in said chordless cycles and determining that the graph is non-planar if the cyclic number of any link exceeds two;
removing vertices having (vertex degree) minus (number of attached links in chordless cycles) equal to 0; and selecting a new base vertex from any vertices remaining in the graph.

13. A computer readable medium containing computer executable code for determining planarity of a graph which adapts a computer to:
determine the number of chordless cycles to which each link of the graph belongs; and
evaluate whether the number of chordless cycles for said each link is less than or equal to two.

14. A computer readable medium containing computer executable code for determining planarity of a graph which adapts a computer to:
select a base vertex of the graph;
construct a minimum distance directed spanning tree from said base vertex;
obtain a cut tree of said spanning tree, said cut tree comprising at least one cut tree link; and
determine if there are any cycles composed of cut tree links.

15. The computer readable medium of claim 14, wherein said determining comprises determining if there are any persistent cycles composed of cut tree links and, if yes, determining that said graph is non-planar.

16. The computer readable medium of claim 15, wherein said determining if there are any persistent cycles composed of cut tree links comprises:
identifying cycles composed of cut tree links;
repetitively, until there are no remaining cycles composed of cut tree links:
selecting the largest cycle composed of cut tree links and forming a sub-graph;
composing a directed spanning tree on said sub-graph; and
determining if cycles composed of cut tree links of said sub-graph exist in said sub-graph and, if so, determining that there is a persistent cycle composed of cut tree links.

17. The computer readable medium of claim 16, wherein said determining if there are any persistent cycles composed of cut tree links further comprises, where there is not a persistent cycle, selecting links forming an open Hamiltonian walk from said sub-graph.

18. The computer readable medium of claim 17, wherein said computer is further adapted to:
include said selected links as cut tree links;
identify cut tree links related to said base vertex;
identify chordless cycles for said identified cut tree links; and
increment a cyclic number for each link in said chordless cycles and determining that the graph is non-planar if the cyclic number of any link exceeds two.

19. The computer readable medium of claim 17, wherein said computer is further adapted to:
remove vertices having (vertex degree) minus (number of attached links in chordless cycles) equal to 0; and
select a new base vertex from any vertices remaining in the graph.

20. An apparatus for determining planarity of a graph comprising:
an input device for inputting said graph;
a computer;
an output device for outputting a planarity result;
wherein said computer is adapted to:
determine the number of chordless cycles to which each link of the graph belongs; and
evaluate whether the number of chordless cycles for said each link is less than or equal to two, indicating planarity.
